(19) United States
(12) Patent Application Publication
(10) Pub. No.: US 2009/0164372 A1
(43) Pub. Date: Jun. 25, 2009

(54) Methods of processing data captured during a deposit transaction conducted at an image-based self-service check depositing terminal

(75) Inventors: Christopher M. Dell, Waterloo (CA); Stephen C. Gawne, Waterloo (CA); Michael Ancell, Kitchener (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/004,362

(22) Filed: Dec. 20, 2007

(51) Int. Cl. G06Q 40/00

(52) U.S. Cl. 705/43; 705/45

(57) ABSTRACT

A method is provided of operating a self-service check depositing terminal. The method comprises the steps of receiving a user identification (ID) card from a depositor at the self-service check depositing terminal, reading ID data from the user ID card, sending the ID data to a consolidation server of a first financial institution to allow the first financial institution to process the ID data, and receiving from the first financial institution a first message containing a first Uniform Resource Locator (URL) which (i) is associated with a consolidation server of a second financial institution which is different from the first financial institution and (ii) is based upon the ID data which has been processed at the first financial institution.

### BACKGROUND

The present invention relates to depositing of checks, and is particularly directed to methods of processing data captured during a deposit transaction conducted at an image-based self-service check depositing terminal such as an image-based check depositing automated teller machine (ATM).

A check depositing ATM allows a user to deposit a check in a public access, unattended environment. To deposit a check, a user inserts a user identification card through a user card slot at the check depositing ATM, enters the amount of the check being deposited, and inserts a check to be deposited through a check slot. A check transport mechanism receives the entered check and transports the check in a forward direction along a check transport path to a number of locations within the ATM to process the check. If the check is not accepted for deposit, the check is returned to the user via the check slot. If the check is accepted for deposit, the amount of the check is deposited into the user's account and the check is transported to and stored in a storage bin within the ATM. An endorser printer prints an endorsement onto the check as the check is being transported to the storage bin.

Checks in the storage bin within the ATM are periodically picked up and physically transported via courier to a back office facility of a financial institution or a third party which is other than a financial institution. At the back office facility, the checks are prepared at a document preparation workstation for subsequent processing in an image-based check processing system located at the back office facility. In a first pass of checks through the image-based check processing system, check image data which is representative of images of the checks is captured. Then in a second pass of checks through an image-based check processing system, the checks are encoded and sorted and matched up with their corresponding check image data which was previously captured during the first pass of checks. The second pass of checks may be made through either the same image-based check processing system that the first pass of checks was made or a different image-based check processing system. Checks ate processed in the first and second passes through the image-based check processing system(s) for purpose of clearing checks between financial institutions, as is known.

As an alternative to capturing check image data in a first pass of checks through an image-based check processing system located at the back office facility (which requires the checks to be physically transported from the ATM to the back office facility before the first pass of checks can be performed), proposals have been made to remotely capture check image data at the check depositing ATM. After check image data is captured in a “first pass” of checks through the check depositing ATM, the remotely-captured check image data is sent electronically to the back office facility. At a later time, the checks are picked up and physically transported via courier to the back office facility. Then, in a “second pass” of checks through an image-based check processing system located at the back office facility, the checks are encoded, sorted, and matched up with their corresponding check image data which was previously captured at the check depositing ATM and sent electronically to the back office facility. In this “second pass”, it is conceivable that check images (instead of physical checks) be processed. If this is the case, then checks need not be picked up at the check depositing ATM and physically transported via courier to the back office facility.

During the “second pass” of checks through the image-based check processing system located at the back office facility, the checks are sorted into different types of pockets including “on-us” pockets and “transit” pockets. The “on-us” checks are checks originally drawn on the same financial institution processing the checks. The “transit” checks are originally drawn on other financial institutions, and need to be cleared through the other financial institutions. The “transit” checks are cleared through the other financial institutions by electronically transmitting transaction data and check image data associated with each check to the financial institution on which the check was originally drawn.

The financial institution or third party operating the back office facility may not be the owner of the check depositing ATM at which the check deposit was initially made. The owner of the check depositing ATM usually owns and operates a network of check depositing ATMs. It would be desirable for the ATM owner to be able to more effectively and efficiently process transaction data including check image data which has been remotely captured at the check depositing ATM.

### SUMMARY

In accordance with one aspect of the present invention, a method of operating a self-service check depositing terminal comprises the steps of receiving a user identification (ID) card from a depositor at the self-service check depositing terminal, reading ID data from the user ID card, sending the ID data to a consolidation server of a first financial institution to allow the first financial institution to process the ID data, and receiving from the first financial institution a first message containing a first Uniform Resource Locator (URL) which (i) is associated with a consolidation server of a second financial institution which is different from the first financial institution and (ii) is based upon the ID data which has been processed at the first financial institution.

In accordance with another aspect of the present invention, a method of operating a consolidation server of a financial institution comprises the steps of receiving identification (ID) data from a self-service check depositing terminal, processing the ID data to provide a uniform resource location (URL), and sending the URL to the self-service check depositing terminal to allow the self-service check depositing terminal to send deposit transaction data and check image data to a consolidation server of another financial institution to allow this financial institution to process the deposit transaction data and check image data.

In accordance with yet another aspect of the present invention, a method of operating a consolidation server of a first financial institution comprises the steps of receiving identification (ID) data from an automated teller machine (ATM), obtaining a uniform resource location (URL) based upon the ID data, and sending the URL to the ATM to allow the ATM to send deposit transaction data and check image data to a consolidation server of a second financial institution to allow the second financial institution to process the deposit transaction data and check image data, wherein the URL is associated with the consolidation server of the second financial institution.

### BRIEF DESCRIPTION OF THE DRAWINGS

In the accompanying drawings:

FIG. 1 is a schematic block diagram of a known system in which a network of check depositing ATMs communicates with a back office of a financial institution which, in turn, communicates with a network of consolidation servers of other financial institutions;

FIG. 2 is a schematic block diagram of a system in which a network of check depositing ATMs communicates with a back office of a financial institution and a network of consolidation servers of other financial institutions in accordance with an embodiment of the present invention;

FIG. 3 is a left-front perspective view of an image-based check depositing ATM constructed in accordance with an embodiment of the present invention;

FIG. 4 is a simplified schematic diagram of a part (a check processing module) of the check depositing ATM of FIG. 3;

FIG. 5 is an elevational view of the check processing module of FIG. 4, looking approximately in the direction of arrow X in FIG. 3, and showing some parts removed and some parts only schematically;

FIG. 6 is a flowchart illustrating steps performed by the check depositing ATM of FIG. 3 during a check deposit transaction in accordance with an embodiment of the present invention; and

FIG. 7 is a flowchart illustrating steps performed by a bank consolidation server during the check deposit transaction illustrated in the flowchart of FIG. 6.

### DETAILED DESCRIPTION

The present invention is directed to methods of processing transaction data and check image data captured during a deposit transaction conducted at an image-based self-service check depositing terminal such as an image-based check depositing automated teller machine (ATM).

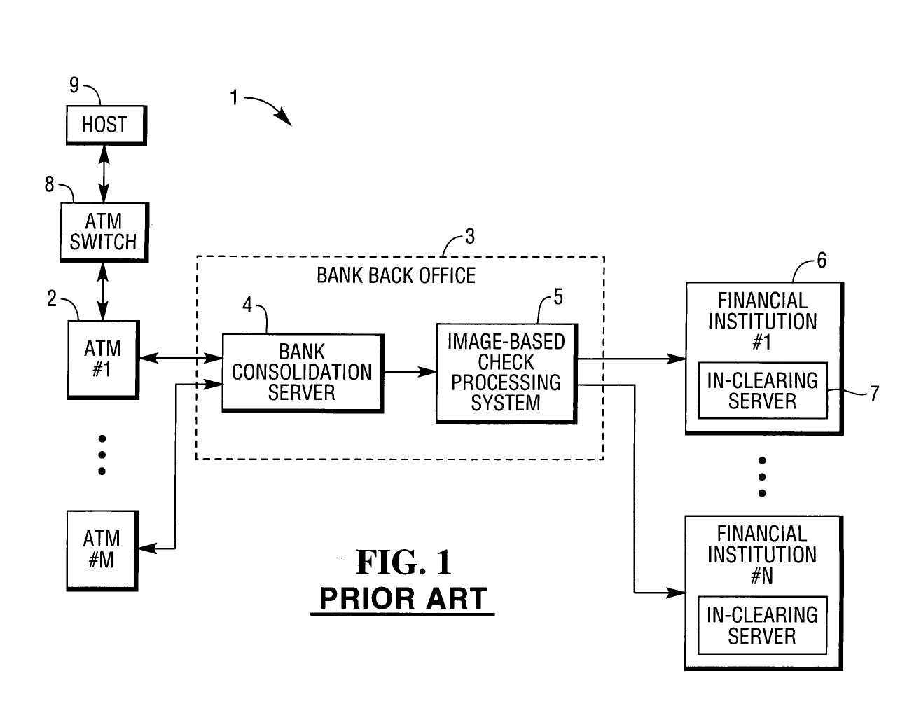

Referring to FIG. 1, a schematic block diagram is illustrated of a known system 1 in which a network of check depositing ATMs 2 (there are “M” ATMs shown in the network of FIG. 1) communicates with a back office facility 3 of a financial institution such as a bank. More specifically, each of the ATMs 2 communicates with an ATM switch 8 which, in turn, communicates with a host 9. The communication between each of the ATMs 2 and the ATM switch 8 and the communication between the ATM switch 8 and the host 9 are conventional and well known. These communications allow a customer one of the ATMs 2 to conduct a financial transaction, such as a check depositing transaction at the ATM.

Each of the ATMs 2 also communicates with a bank consolidation server 4 of the bank. The bank consolidation server 4 communicates with an image-based check processing system 5 usually located at the same back office facility location as the bank consolidation server. The image-based check processing system 5 may comprise the Model iTRAN 8000 Item Processing System, manufactured by NCR Corporation, located in Dayton, Ohio.

The image-based check processing system 5 processes checks in a known manner to clear checks between the bank and other financial institutions 6 (there are “N” other financial institutions shown in FIG. 1). More specifically, the image-based check processing system 5 transmits transaction data and check image data to check processing systems including in-clearing servers 7 associated with the other financial institutions 6. Each one of the in-clearing servers 7 is associated with a corresponding one of the other financial institutions 6. Each one of the in-clearing servers 7 processes transaction data and the check image data in a known manner to clear checks associated with the particular one of the financial institutions 6.

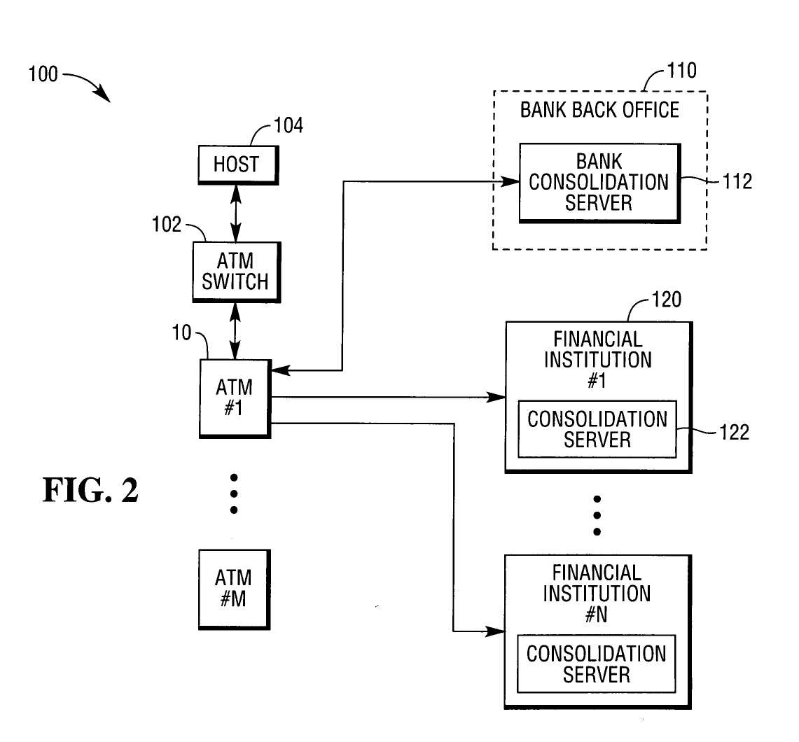

Referring to FIG. 2, as schematic block diagram is illustrated of a system 100 in accordance with an embodiment of the present invention. A network of check depositing ATMs 10 (there are “M” ATMs shown in the network of FIG. 2) communicates with a back office facility 110 of a financial institution such as a bank. More specifically, each of the ATMs 10 communicates with an ATM switch 102 which, in turn, communicates with the host 104. The communication between each of the ATMs 10 and the ATM switch 102, and the communication between the ATM switch 102 and the host 104 are conventional and well known. These communications allow a customer at one of the ATMs 10 to conduct a financial transaction, such as a check depositing transaction, at the ATM.

Each of the ATMs 10 also communicates with a consolidation server 112 of the bank. For simplicity, only ATM #1 shown in FIG. 2 is shown communicating with the bank consolidation server 112. Also, each of the ATMs 10 communicates with other financial institutions 120 (there are “N” other financial institutions shown in FIG. 2). For simplicity, only ATM #1 shown in FIG. 2 is shown communicating with the financial institutions 120. More specifically, each of the ATMs 10 communicates with consolidation servers 122 associated with the financial institutions 120. Each one of the consolidation servers 122 is associated with a corresponding one of the financial institutions 120. Each one of the ATMs 10 transmits transaction data and check image data to the consolidations servers 122 associated with the financial institutions 120. Each one of the consolidation servers 122 processes transaction data and the check image data in a known manner to clear checks associated with the particular one of the financial institutions 120.

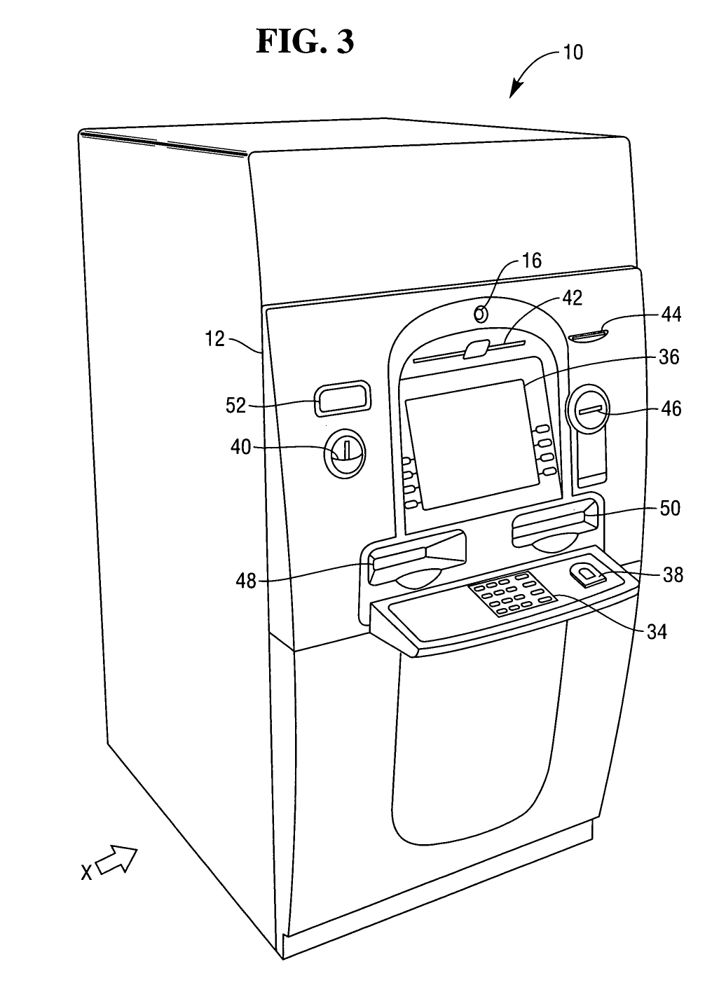

Referring to FIG. 3, the check depositing ATM 10 comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

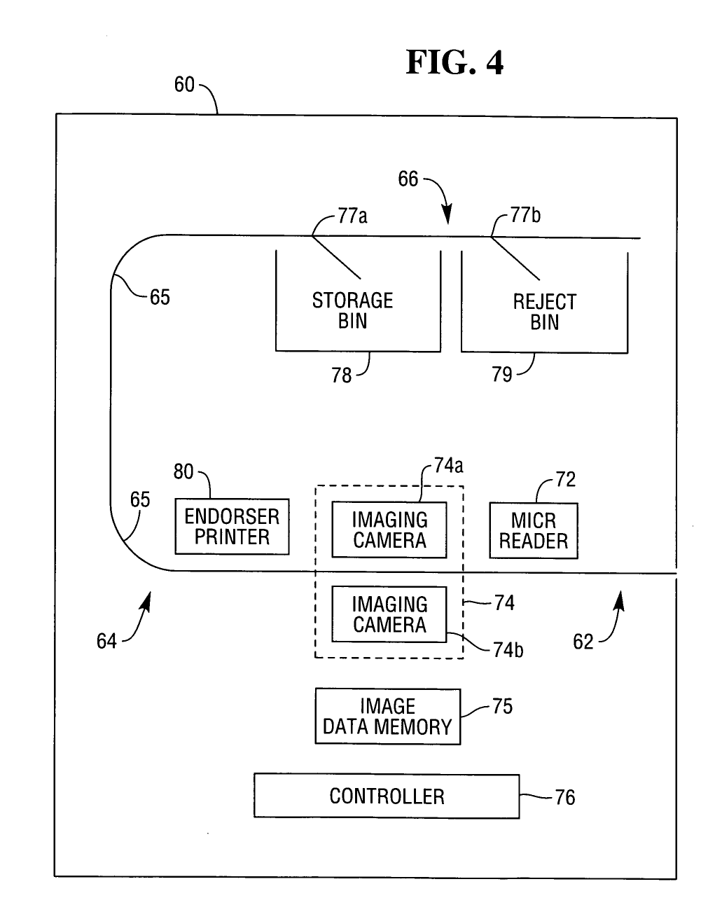

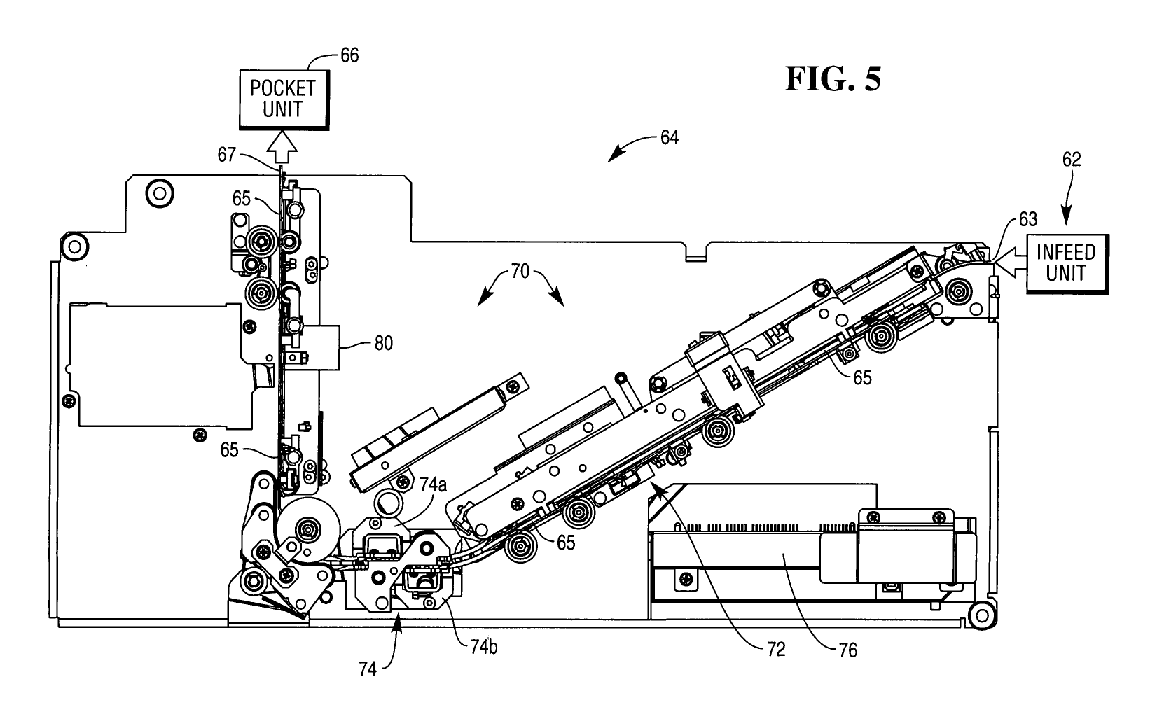

A check processing module (CPM) 60 will now be described with reference to FIG. 4 and FIG. 5. FIG. 4 is a simplified schematic diagram of part of the fascia 12 and main parts of the CPM 60. FIG. 5 is an elevational view of the check processing module of FIG. 4, looking approximately in the direction of arrow X in FIG. 3, and showing some parts removed and some parts only schematically. The CPM 60 is a modified version of a conventional check processing module, such as the check processing module provided with the PERSONAS (trademark) 6676 NCR ATM.

The CPM 60 comprises three main units which includes an infeed unit 62, a transport unit 64, and a pocket unit 66. The infeed unit 62 receives a check which has been deposited into the check input/output slot 42, and transports the check to an inlet 63 of the transport unit 64. The dimensions of the infeed unit 62, such as its run length, may vary depending upon the particular model ATM the CPM 60 is installed. The structure and operation of the infeed unit 62 are conventional and well known and, therefore, will not be described.

The transport unit 64 includes a check input/output transport mechanism 70 which includes an alignment mechanism for aligning a check. The transport mechanism 70 receives a check from the inlet 63, and transports the check along a document track 65 to an outlet 67 of the transport unit 64. The transport unit 64 further includes a magnetic ink character recognition (MICR) head 72 for reading magnetic details on a code line of a check. The transport unit 64 also includes an imager 74 including an upper 74a and lower 74b imaging camera for capturing an image of each side of a check (front and rear). An endorser printer 80 is provided for printing endorsements onto checks. An image data memory 75 is provided for storing images of checks. A controller 76 is provided for controlling the operation of the elements within the CPM 60.

The pocket unit 66 includes a storage bin 78 for storing processed checks. The pocket unit 66 further includes a reject bin 79 for storing rejected checks. Two divert gates 77a, 77b are provided for diverting checks to either the storage bin 78 or the reject bin 79. The structure and operation of the pocket unit 66 are conventional and well known and, therefore, will not be described.

The CPM 60 is of a type which processes only one check at a time. Once a check is received for processing, the check must be deposited into a bin (i.e., either the storage bin 78 or the reject bin 79) before another check can be received for processing. This type of check processing module is sometime referred to as a single-check acceptor.

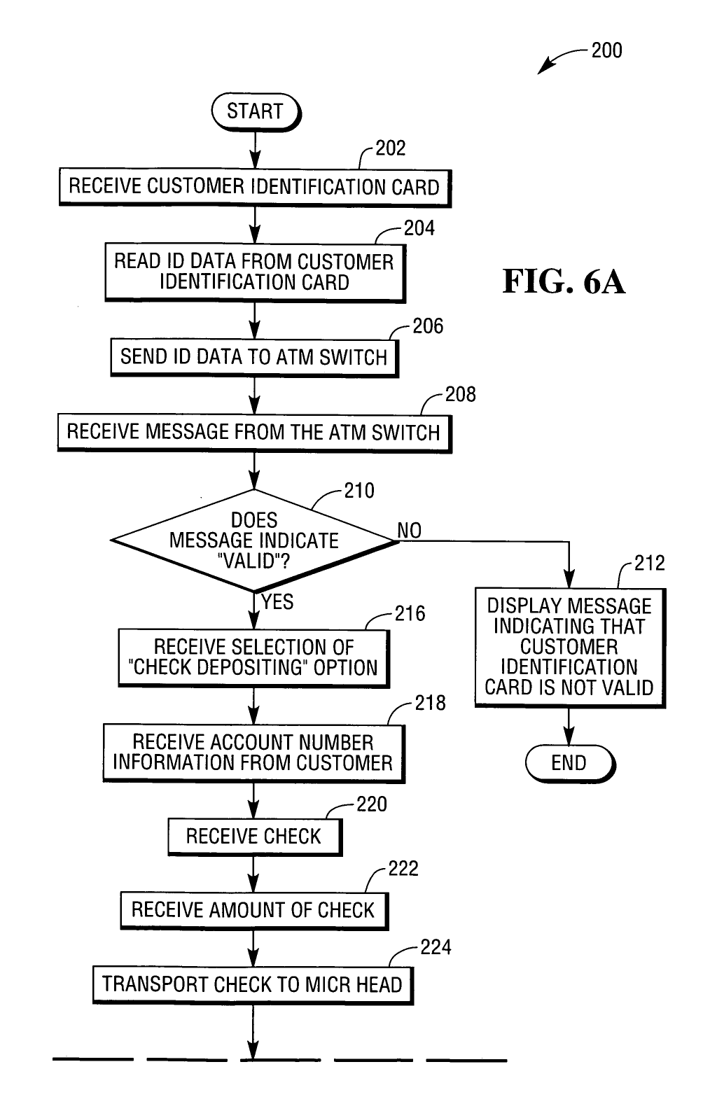

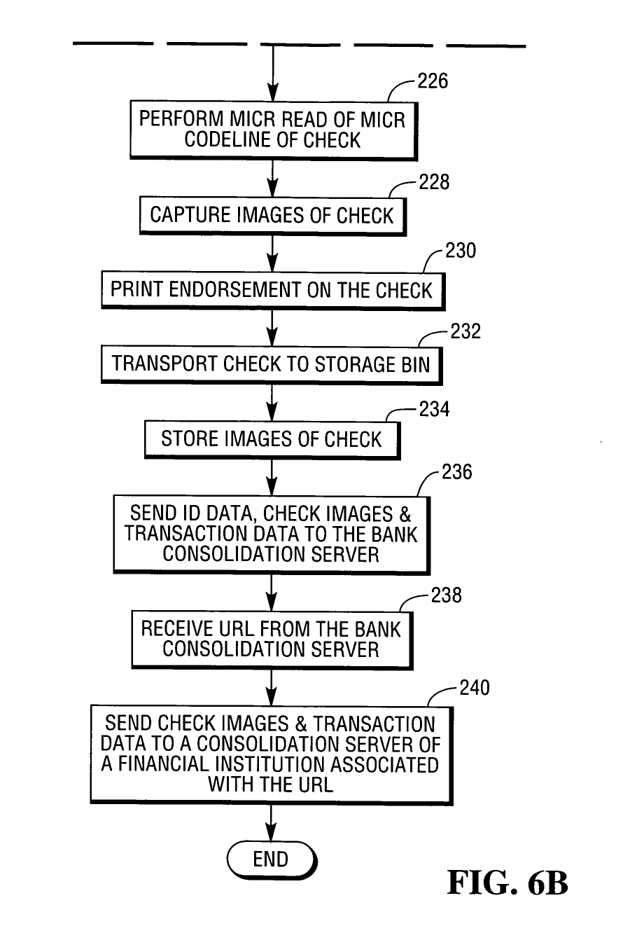

Referring to FIG. 6, a flowchart 200 illustrates steps performed by the check depositing ATM 10 during a check depositing transaction in accordance with an embodiment of the present invention. In the check depositing transaction, the ATM customer inserts a customer identification card into the card reader slot 46 and enters identifying data, like a personal identification number (PIN) to start the transaction (step 202). The ATM 10 reads ID data from the ID card (step 204), and then sends the ID data to the ATM switch 102 (step 206). The ATM switch 102 and the host 104 cooperate together to process the ID data received from the ATM ID.

After the ID data received from the ATM 10 is processed, the ATM receives a message from the ATM switch 102 (step 208). A determination is made as to whether the message received from the ATM switch 102 is valid based upon the ID data which has been processed by the ATM switch 102 (step 210). If the determination made in step 210 is negative (i.e., the ID data which has been processed by the ATM switch 102 and the host 104 is not valid), then a message is displayed on the display 36 (FIG. 3) to inform the ATM customer that the ID data read from the customer ID card, and therefore the customer ID card itself, is not valid.

However, if the determination made in step 210 is affirmative, (i.e., the ID data which has been processed by the ATM switch 102 and the host 104 is valid), then the process proceeds to step 216. In step 216, the ATM customer is presented with a screen on the display 36 to select a transaction from a list of transaction options, and selects the “check depositing” option. The ATM customer also selects an account into which the deposit is to be made (step 218).

The ATM customer inserts the check (step 220), and enters the amount of the check (step 222). The controller 76 (FIG. 3) receives the amount of the check. The infeed unit 62 receives the check and transports the check to the inlet 63 of the transport unit 64 (FIGS. 4 and 5). The transport mechanism 70 of the transport unit 64 receives the check and transports the check (step 224) to the MICR head 72 where the MICR codeline on the check is read (step 226). The transport mechanism 70 transports the check to the imager 74, where both sides of the check are imaged (step 228). The endorser printer 80 prints endorsement data onto the check (step 230). The endorsed check is then transported through the outlet 67 to the storage bin 78 of the pocket unit 66 (step 232) for subsequent collection and further processing. The captured check images are stored in the image data memory 75 (step 234). The check images may be stored locally to the ATM 10. For example, the check images may be stored on an ATM hard drive located within the ATM 10 for a period of time determined by the financial institution.

The ID data, check images, and transaction data are also sent to the bank consolidation server 112 for further processing in the back office facility 110 (step 236). Then in step 238, after the bank consolidation server 112 has further processed the ID data, the check images, and the transaction data, a Uniform Resource Locator (“URL”) is received from the bank consolidation server. More specifically, the particular URL received from the bank consolidation server 112 depends upon the particular ID data which has been sent from the ATM 10 to the bank consolidation server. Based upon the URL received from the bank consolidation server 112 in step 238, the ATM 10 sends check image data and transaction data to a consolidation server associated with one of the other financial institutions 120 (step 240). It should be noted that the particular one of the consolidation servers 122 to which the check image data and the transaction data are sent depends upon the particular URL which, in turn, depends upon the particular ID data which was read from the customer ID card. Thus, the particular one of the consolidation servers 122 to which the check image data and transaction data are sent depends upon the particular customer ID card.

It should be apparent that steps 202 through 234 just described hereinabove in the flowchart 200 of FIG. 6 are based upon communication between the ATM 10 and the ATM switch 102 (FIG. 2) or the ATM itself. It should also be apparent that steps 236 through 238 just described hereinabove in the flowchart 200 of FIG. 6 are based upon communication between the ATM 10 and the bank consolidation server 112. Step 240 just described hereinabove in the flowchart 200 of FIG. 6 is based upon communication between the ATM 10 and a particular one of the consolidation servers 122 shown in FIG. 2.

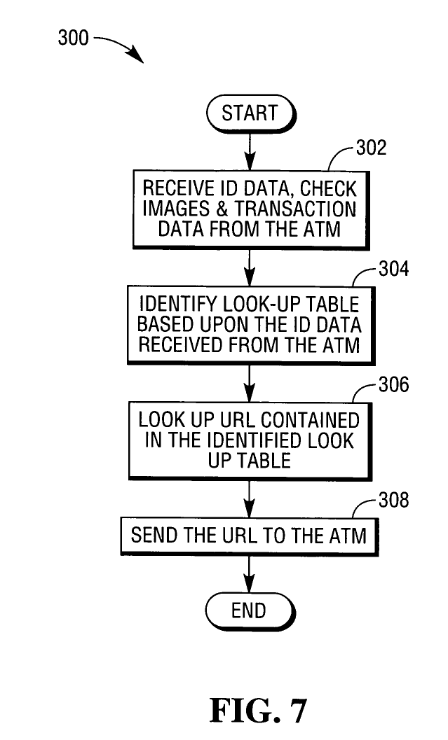

Referring to FIG. 7, a flowchart 300 illustrates steps performed by the bank consolidation server 112 (FIG. 2) during the check depositing transaction illustrated in the flowchart of FIG. 6, in accordance with an embodiment of the present invention. In response to the ATM 10 sending ID data, check image data, and transaction data (see step 236 in FIG. 6), the bank receives this data (step 302 in FIG. 7).

Then in step 304, a look-up table is identified based upon the particular ID data received from the ATM 10. This particular ID data was stored on the customer ID card to identify the particular one or more of the other financial institutions 120 (FIG. 2) which have “signed up” with the network of ATMs 10 to receive check image data and transaction data directly from this network of ATMs 10. More specifically, the particular ID data contains a “pointer” to a specific look-up table which contains the URL of a particular financial institution which has signed up with the network of ATMs 10 to receive check image data and transaction data directly therefrom. After the look-up table is identified in step 304, the URL contained in the identified look-up table is retrieved (step 306) and then sent to the ATM 10 (step 308).

When the ATM 10 is ready to send check images and transaction data to a consolidation server (see step 240 in FIG. 6), the ATM 10 knows which particular one of the financial institutions 120 (FIG. 2) to send the data to based upon the URL sent from the bank consolidation server 112 to the ATM 10 back in step 308. The consolidation server of the particular one of the financial institutions 120 (FIG. 2) then processes this check image data and transaction data in a conventional manner to clear checks associated with the check image data and transaction data.

It should be apparent that the above description describes a check depositing process in which transaction data and check image data associated with check deposit transactions conducted at the ATM 10 are transmitted to the consolidation servers 122 of different financial institutions 120 based upon the ID data contained on a customer ID card. The ATM 10 sends transaction data and check image data to consolidation servers of a multiple number of financial institutions, such as banks, regardless of who owns the particular ATM. This capability allows the ATM owner (who may or may not be a bank) to support check deposits on a multiple number of “foreign” institutions with a common solution. A “foreign” institution is defined as any institution which does not own the ATM at which the check deposit transaction is being conducted.

Since the ATM owner has the capability to support check deposits on a multiple number of “foreign” institutions, it should be apparent that the ATM owner can charge each “foreign” institution a fee for signing up with the ATM owner so that customers of the “foreign” institution can conduct check deposit transactions at the particular ATM (or network of ATMs) using the above-described common solution. When the “foreign” institution signs up with the ATM owner, the URL associated with this particular “foreign” institution is stored in the look-up table at the back office facility 110 (FIG. 2) so that the consolidation server 112 at the back office facility can supply this URL in the process of FIG. 7 as previously described hereinabove.

It should also be apparent that a “foreign” institution can virtually extend its footprint to accept check deposits through another institution's ATMs. The extended footprint provided in this virtual environment is provided at relatively low cost since high costs, such as costs associated with ATM deployments by the “foreign” institution, are not needed.

Although the above description describes a URL being contained in a look-up table, it is conceivable that multiple URLs may be contained in a particular look-up table. Each URL would be associated with another financial institution which has “signed up” with the particular network of ATMs.

Also, although the above-description describes the PERSONAS (trademark) 6676 NCR ATM embodying the present invention, it is conceivable that other models of ATMs, other types of ATMs, or other types of self-service check depositing terminals may embody the present invention. Self-service depositing terminals are generally public-access devices that are designed to allow a user to conduct a check deposit transaction in an unassisted manner and/or in an unattended environment. Self-service check depositing terminals typically include some form of tamper resistance so that they are inherently resilient.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A method of operating a self-service check depositing terminal to allow checks to be cleared between a first financial institution and a second financial institution which is different from the first financial institution, the method comprising the steps of:
receiving a user identification (ID) card from a depositor at the self-service check depositing terminal;
reading ID data from the user ID card;
sending the ID data to a check data consolidation server of the first financial institution to allow the first financial institution to process the ID data;
receiving from the first financial institution a first message containing a first Uniform Resource Locator (URL) which (i) is associated with a check data consolidation server which is other than an authentication server of the second financial institution and (ii) is based upon the ID data which has been processed at the first financial institution; and
sending transaction data and check image data to the check data consolidation server which is other than an authentication server of the second financial institution based upon the first message containing the first URL so that checks can be cleared between the first and second financial institutions.

2. (canceled)

3. A method according to claim 1, further comprising:
receiving from the first financial institution a second message containing a second (URL) which (i) is associated with a check data consolidation server which is other than an authentication server of a third financial institution which is different from the first and second financial institutions and (ii) is based upon the ID data which has been processed at the first financial institution.

4. A method according to claim 3, further comprising:
sending first deposit transaction data and check image data to the check data consolidation server which is other than an authentication server of the second financial institution based upon the first message containing the first URL so that checks can be cleared between the first and second financial institutions; and
sending second deposit transaction data and check image data to the check data consolidation server which is other than an authentication server of the third financial institution based upon the second message containing the second URL so that checks can be cleared between the first and third financial institutions.

5. A method according to claim 4, wherein the first and second messages comprise a single message.

6. A method of operating a check data consolidation server which is other than an authentication server of a financial institution, the method comprising the steps of:
receiving identification (ID) data from a self-service check depositing terminal;
processing the ID data to provide a uniform resource location (URL); and
sending the URL to the self-service check depositing terminal to allow the self-service check depositing terminal to send deposit transaction data and check image data to a check data consolidation server which is other than an authentication server of another financial institution to allow this financial institution to process the deposit transaction data and check image data so that checks can be cleared between the financial institutions.

7. A method according to claim 6, wherein the URL is contained in a look-up table.

8. A method of operating a check data consolidation server which is other than an authentication server of a first financial institution to clear checks between the first financial institution and a second financial institution, the method comprising the steps of:
receiving identification (ID) data from an automated teller machine (ATM);
obtaining a uniform resource location (URL) based upon the ID data; and
sending the URL to the ATM to allow the ATM to send deposit transaction data and check image data to a check data consolidation server which is other than an authentication server of the second financial institution to allow the second financial institution to process the deposit transaction data and check image data so that checks can be cleared between the first and second financial institutions, wherein the URL is associated with the check data consolidation server which is other than an authentication server of the second financial institution.

9. A method according to claim 8, wherein the URL is obtained from a look-up table stored at the check data consolidation server which is other than an authentication server of the first financial institution.

10. A method according to claim 8, wherein the ID data is associated with a customer identification card of an ATM customer conducting a check depositing transaction at the ATM.
